(19) United States
(12) Patent Application Publication
(10) Pub. No.: US 2007/0094091 A1
(43) Pub. Date: Apr. 26, 2007

(54) Peer-to peer reselling of software programs with payback

(76) Inventors: Viktor Chabourov, Leimen (DE); Elena Chabourova, Leimen (DE)

Correspondence Address: Maria Nilova;Patentica C\O Landon-IP, Inc., Suite 450, 1700 Diagonal Road, Alexandria, VA, 22314, US

(21) Appl. No.: 11/256,953

(22) Filed: Oct. 25, 2005

(51) Int. Cl. G06Q 30/00

(52) U.S. Cl. 705/26

(57) ABSTRACT

A method and system for peer-to-peer reselling of a software program, comprising creating a new installable version of the software program on a first computer device, transferring the new version to another computer device, executing transaction to purchase the software program and enabling a payback mechanism so that the first user receives a payback.

### TECHNICAL FIELD

The present invention relates generally to electronic communication, in particular, to a method and system for effecting secure electronic transactions, such as software purchases, and more particularly to a method and system for online and off-line purchases of software, in particular, shareware, providing re-selling programs with the possibility for a re-seller to receive a payback.

### BACKGROUND OF THE INVENTION

There are several companies that create software for Pocket PC and Palm devices. Some companies sell the software from their own websites and most of them use shareware portals to market and sell software. The main Pocket PC shareware portals are handago.com and pocketgear.com.

These portals keep catalogs of shareware software from different vendors, provide possibilities to download and purchase software. End user can download shareware software, use it for a trial period and purchase software from these shareware portals.

Shareware portals provide the possibility for reselling software to other web resources, like popular news websites. These websites add pages with software programs and links for purchasing programs from shareware portals. Each user buying software using a link that comes from these websites receives a payback.

There are other ways of reselling, such as marketing campaigns, when one user can recommend software to another user, such as a friend. The friend can buy a recommended program from shareware portal and has to enter referrer name, email or ID during payment process. If this happens, then the first user receives a payback or discount to buy other programs.

This is usually performed by sending to the end-user an email with an offer to resend it to a friend who might be interested.

Another solution is sending a post mail with promotion codes that can be passed to another person.

Typically, to effect a software purchase, a user shall go online, connect a computer device to a software provider, perform multiple steps to effect secure electronic transaction, such as entering address and credit card information, referrer name, receiving a registration key, or a password, enter this to enable the software, etc.

In case of purchasing of software for handheld devices, this multi-step process becomes fraught with error and confusion for the end-user. Many of these steps have conspired to create a barrier to online software purchases because the user typically must perform numerous steps before the online software purchase is completed.

There are solutions on the market that integrate payment screens directly into the programs and capture credit card and other information to send it to transaction server.

Such systems are more convenient for software users, however, existing technical solutions don't provide the possibility to resell software programs in face-to-face meetings, having only PDAs at hand.

Even in case users of Palm devices exchange programs by transferring them over infrared port, there is no possibility to track who sent the program and no computerized method to give payback upon the purchase of the transferred program.

Moreover, in view of the global problem relating to illegal peer-to-peer file-sharing practice resulting in copyright infringement, there is an acute need in easy and user-friendly mechanism for providing legal peer-to-peer re-selling with payback that will encourage the end users to exchange programs legally and will benefit to vendors and software developers.

### BRIEF SUMMARY OF THE INVENTION

The object of the present invention is to provide a method and system for re-selling of shareware programs and providing a payback mechanism.

Another object of the present invention is to provide a method and system for the end-users to resell any other digital goods, such as audio and video files, images, documents, electronic books, ring tones, etc, and collect payback from a server or website.

A further object of the invention is to provide a method and system for re-selling of shareware programs with the possibility to donate payback.

A further object of the invention is to provide an easy and user friendly method and system for legal exchange of programs that someone is using or used and which this someone wants to share with a friend because it is for example, the best program on the market. As a result, each party benefits: the end-user receives software of higher quality and saves time on searching for it, the re-seller receives a payback encouraging him for further re-selling and the service provider increases sales volume.

The above and other objects and problems are addressed by the embodiments of the present invention, which provide a method and system for re-selling software online, including a plug-in used by a software application running on a computing device to enable re-selling of software with payback, while the computing device is offline. When two users decide to exchange a program, the plug-in on a first user computer device creates a new installable version of the program intended for re-selling, which captures the first user ID, such as email, which is transferred on to the second user computer device along with this new installable version of the program. The second user can install and try the program. He is also presented from time to time with the offer to purchase the program. If he clicks on a “Buy” button, he is presented with a dialog to enter his credit card, address and email information to effect a purchase. After he confirms the entered data and approves the purchase, the transferred software is enabled on his computer, but the software purchase is pending until the computing device goes online. When online, the second user's computer device communicates with a service provider for the online software purchase system to complete the pending transaction and also transfers the information on the first user that enables the service provider to effect the payback to the first user for re-selling of this software.

In one aspect, a method for peer-to-peer reselling of software is provided, comprising the steps of:
creating a new installable version of a software program on a first user hardware device, wherein the software comprises embedded mechanism for enabling reselling of the software program;
transferring the software program to the second hardware device, whereby a second user can start using the software program;
enabling transaction to purchase the software program when connecting the second hardware device to the server;
enabling payback mechanism when connecting the second hardware device to the server by passing ID of the first user along with transaction data to a provider server.

According to one example implementation, a computerized method of peer-to-peer reselling of software comprises installing a software program having embedded re-selling mechanism on a first user's computer, whereupon, it can be recorded on a portable program carrier, such as a SD card or Flash-card, and transferred and installed on a second user's computer, whereby the second user can start using the new program immediately after installation, while the purchase can be effected later, and the first user is paid back for reselling the software program.

Preferably, the payback can be received as follows. The second user enters has credit card data and confirms the payment. He connects his hardware device online, whereby the transaction data are passed to a transaction server and the payment is completed. Along with payment data, the first user ID is passed to the server. Thus, the reseller is identified on the server and his virtual account is incremented by a sum of payback. If no virtual account exists for this ID, it is created on the server using the user ID. Then the first user receives a notification about the payback. He can log on to the server and view details. He can spend the payback when purchasing another programs or request a withdrawal of the accumulated sum to his bank account, if the sum is sufficiently big.

In another example implementation, a computerized method of reselling software is provided, wherein a software program having embedded re-selling mechanism is copied or stored on a first user's computer but the first user does not want to install it on his computer and just want to resell it to another user, or the other computer device. In this case, the first user creates a new installable version of the software on his computer and sends it by email for installing on a second user's computer, whereby the second user can start using the new program immediately after installation, while the purchase can be effected later, and the first user is paid back for reselling the software program.

Preferably, the payback can be performed by passing ID, like an email address of the first user with a program installable to the second user computer by storing the payback email within the installable and writing it to into the second user computer upon installation (for example into registry), so that, whereupon the transaction is executed, the first user's email is retrieved and passed to a service provider's server to enable the payback.

In this way, the reseller of this application can be identified and his virtual account can be incremented by the amount of payback. Furthermore, the reseller can be notified by a notification email that his account has been incremented.

Other type of identifier can be also used, like a first user's name or a unique computer ID to identify a reseller at the service provider's server.

This reselling possibility is enabled in the application by providing a client-side SDK that can be integrated by shareware developers into the programs.

The software transferred in this way allows purchasing directly on a device.

When integrating the above described plug-in into a software program, a software developer can further use an optional functionality providing that once the re-sold software is installed on the second user device, it doesn't accept the registration key of the first PDA user, to exclude users-from exchanging registration keys.

Preferably, the information stored on a SDK can contain reselling screens, information screens, end-user help documentation and developer integration documentation. Further, it can contain offline payment screens, such as well known in the art and described in various patent applications, e.g. W02004/042515, the complete specification of this application being incorporated by reference herein, and others.

A computerized method for reselling software according to the invention can be used, for example, for reselling shareware, like business applications, organizers, dictionaries, translators, utilities, programs for communication, computer games, etc.

Preferably, the method is intended for reselling software for PDA's, like Pocket Pc OS PDAs and Palm OS PDAs, other handheld computers , smartphones, mobile phones with Symbian OS and other types of mobile phones that allow installation of custom programs too.

The method can be also used for reselling software for desktop computers. Desktop software program can contain reselling screens that enable to possibility to write installable on a CD or other transfer medium with ID of reseller. The CD can be passed to a second person and program can be installed from CD. Once purchasing process for this program is started, ID of the first user is passed and he receives payback.

In still another aspect, a computer system for peer-to-peer reselling of software programs is provided, comprising
means for creating a new installable version of a software program on a first user hardware device, wherein the software comprises embedded mechanism for enabling reselling of the software program;
means for transferring the software program to a second hardware device, whereby a second user can start using the software program;
means for enabling transaction to purchase the software program when connecting the second hardware device to the server;
means for enabling payback mechanism if software program was bought when connecting the first hardware device to the server.

Preferably the embedded mechanism for enabling the reselling comprises a reselling user interface module, CAB creation module, network listener service. In another aspect of the invention, a method of reselling software comprises building a stand-alone application that allows reselling of the products existing on the market without any integration.

Preferably, the application contains a database of vendors. Further, the application contains information about application names, icons, prices and optionally, a program registration key and a path in the registry where the registration key is stored.

The end user starts the application. The application compares the programs he has already installed on his computer with the list of programs in this database. Then, it displays to the end-user a list of programs that are available for reselling. The user chooses programs he wants to resell to a friend. The user then selects the programs and the reselling application creates installations of these programs which can be further recorded on a card along with the installation of the reselling application. When another user installs a program from the card, first, the reselling application is installed, and second, the resold application itself. Startup path to the resold application is corrected in such a way that, when the resold program is started, it starts before own launch the reselling application. The reselling application retrieves from its vendor database a price, icon and optionally, some other information, and displays to end-user a dialog with an offer to pay for the received program. The dialogs flow looks in the same way as in scenario with the above described plug-in. Once the new user enters a credit card data, the reselling application connects to a transaction server (when Internet connection is available) and completes the payment. Then, it receives a registration key for the program and a path where in registry it should be written. It writes the registration key into the registry and, thus the resold program is enabled into a full-functional and time-unlimited version. The payment process is completed. Now the second user in the same way can start the reselling application to resell programs to his friends. It is possible that a vendor application has more complex registration functionality than a simple registration key in the registry. In this case, after transaction is processed, the user receives popup messages with a description of steps he has to implement to activate the program on his PDA.

In still another aspect of the invention, a computer program product for reselling a software is provided, the computer program product comprising: a computer readable program code means for creating a new installable version of a software program on a first user hardware device; wherein the new version comprises an embedded mechanism comprising a computer readable program code means for creating a new installable version of the software program to transfer to a second computer device; a computer readable program code means for transferring the software program to the second hardware device, whereby a second user can start using the software program; a computer readable program code means for enabling transaction to purchase the software program when connecting the second hardware device to the server; a computer readable program code means for enabling a payback mechanism when connecting the first hardware device to the server.

### BRIEF DESCRIPTION OF THE SEVERAL VIEWS OF THE DRAWINGS

FIG. 1 is a block diagram illustrating a reselling process according to the invention in its most general way;

FIG. 2 is a message flow diagram illustrating a the message flow during the reselling process according to the invention;

FIG. 3 shows an example user interface of a shareware program provided with Re-sell buttons according to the invention;

FIGS. 4a-4d illustrate the procedure of reselling a software using a computer program product according to the invention;

FIG. 5 illustrates a message flow when effecting a payment according to the invention;

FIGS. 6a and 6b illustrate a sample scenario of reselling a software program according to the invention;

FIGS. 7a, 7b and 7c illustrates embodiments of a system and method for reselling software according to the invention;

FIG. 8 illustrates a message flow during integration of a reselling functionality into a software program;

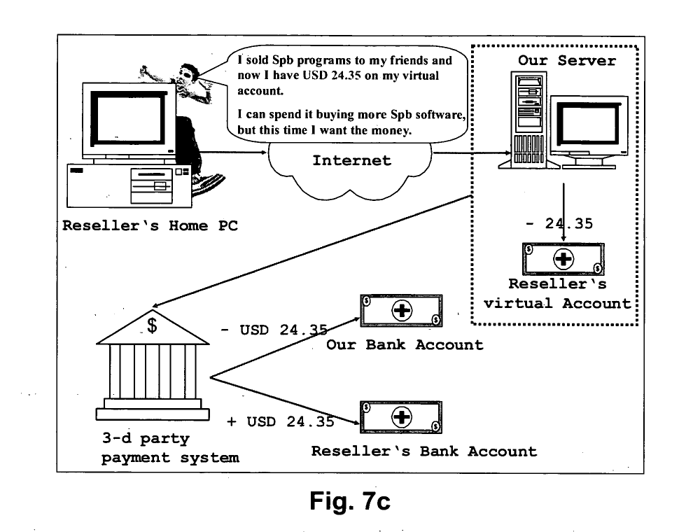

FIG. 9a-9b show an example interface of a shareware program provided with Try/Buy buttons according to the invention;

FIG. 10 shows components integrated into a software installed on a hardware device.

For clarification purposes, it shall be appreciated that the following definitions are used throughout the present specification:

PDA—Personal Data Assistant. This is a small portable computer with an operating system, like Pocket PC, Palm or other. In the document this concept also includes mobiles with SmartPhone and Symbian systems.

Shareware program—a software program with a freely downloading trial version. This trial version either function or time limited or both. The user can buy a program and register it to a full-functional time-unlimited version.

Digital goods are shareware programs, audio and video files, images, documents, electronic books, ring tones. In this patent application we speak mainly about shareware programs, but the patent can be generalized to any type of digital goods.

Removable storage medium—this is a wide range of types of cards, that can be used to transfer data from one PDA to another. Examples are SD cards, Compact Flash cards, Memory cards, etc. And from one desktop computer to another, such as CD, DVD, diskettes, etc.

SDK—a software development kit, a functionality separated in a library that can be integrated within other program.

### DETAILED DESCRIPTION OF THE INVENTION

The present invention will be further described with reference to the attached drawings.

The present invention provides users with the possibility to resell software they bought to another person in a direct contact, anywhere and anytime.

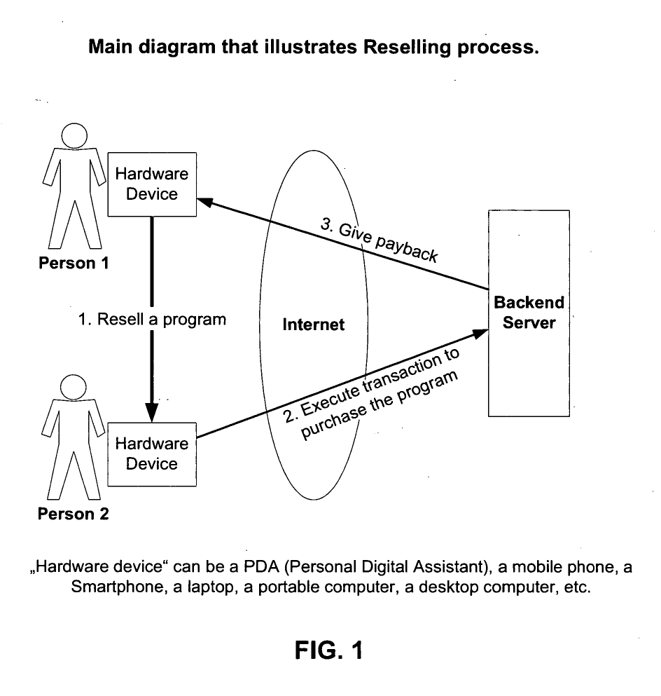

The invention is illustrated in its most general way in FIG. 1 showing the main steps of the reselling process, such as reselling a program, executing a transaction to purchase the program and receiving a payback.

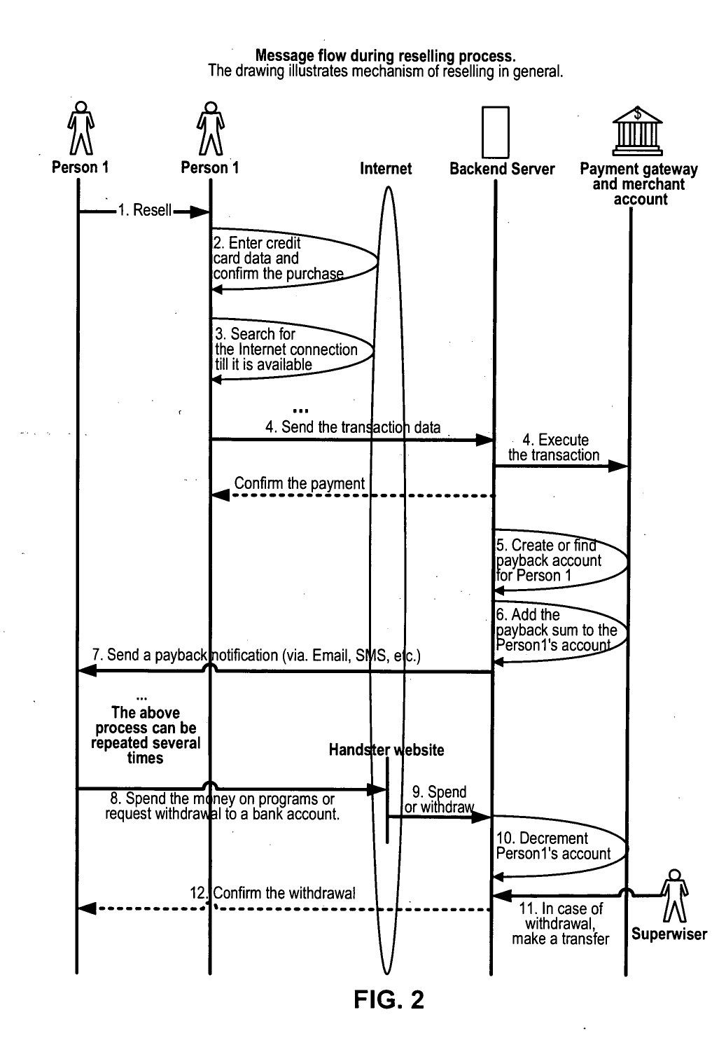

The invention is further illustrated in more detail in FIG. 2 showing message flow during the process of reselling in its most general way.

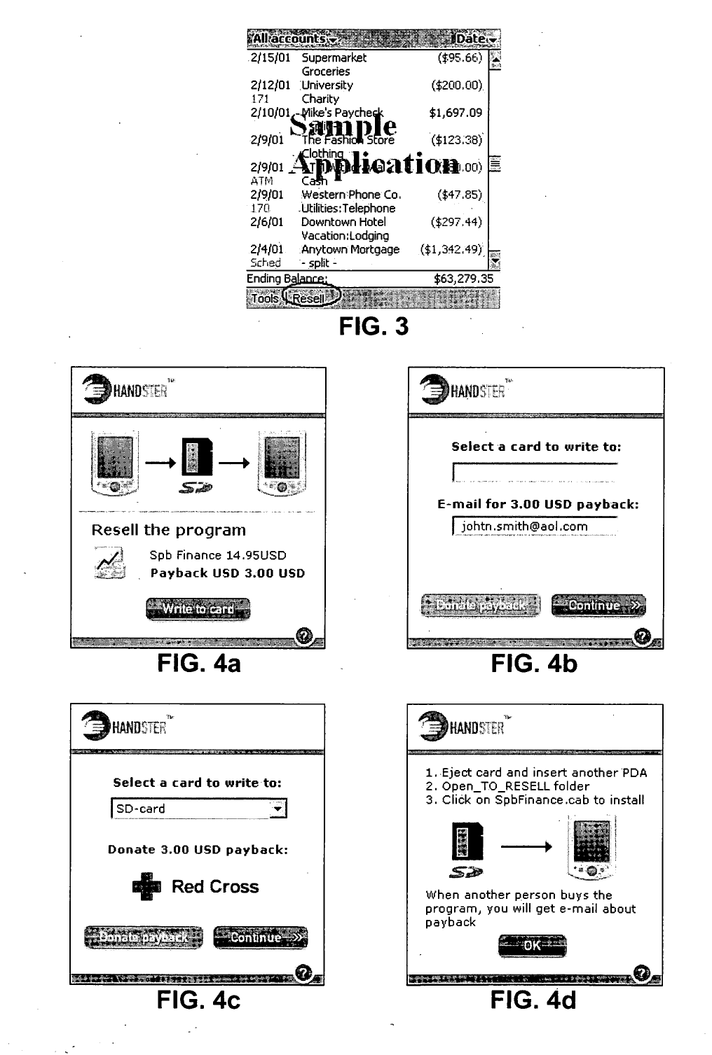

An example user interface of a shareware program provided with Re-sell buttons is presented in FIG. 3. As shown in FIG. 3, the end-user can invoke a “Resell” (FIG. 3) option on a shareware program. One implementation of this is “Resell” button in the program interface.

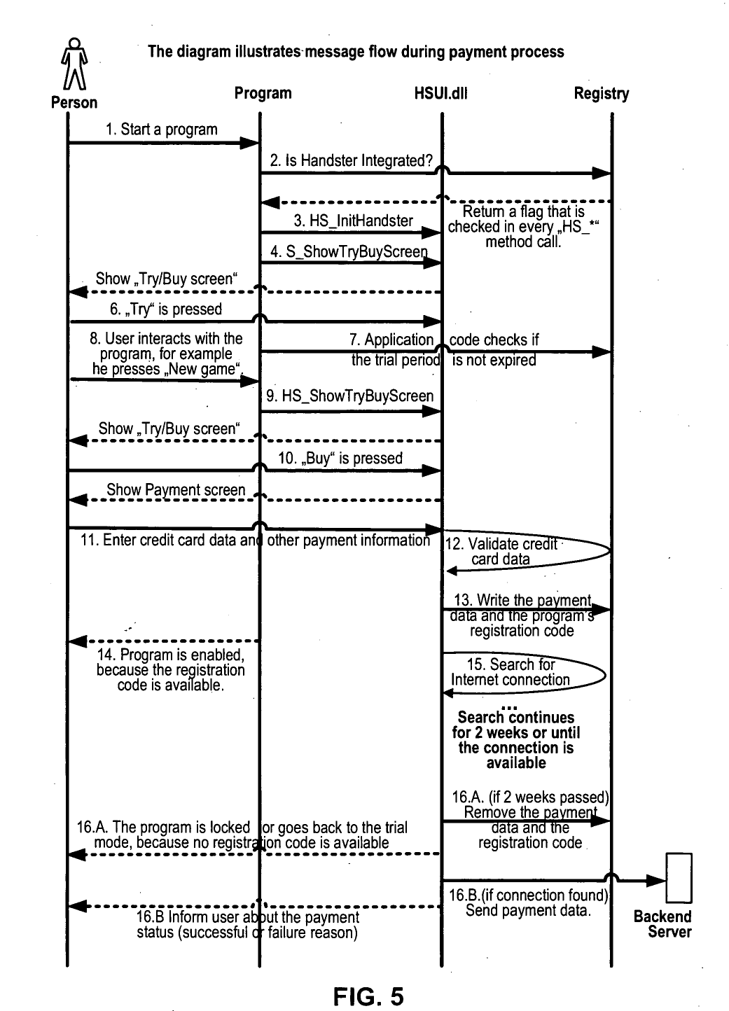

Once invoked, the Resell displays a screen with information about the product, its price and the payback reseller could receive (FIG. 4a). The user can choose to write the installable of program on the card.

In the current implementation, the transfer can be performed using storage medium, like SD card or Flash-card. In the other implementation it can be an infrared beaming, the Bluetooth transfer or any other peer-to-peer way of transfer.

In the next dialog (FIG. 4b) he can select the card to write to and check his email. Default value for the email is retrieved from the device user settings. He can enter any email here. Once the program is purchased by the person who installed it from this card, the email with a payback notification is sent to this email address.

The reseller can save the installable of shareware on a removable storage medium. During this process, the reseller receives information about the payback he gets for reselling this program and chooses the way he prefers to be notified about payback.

The price of a shareware program usually varies from 5 to 70 USD. Payback is roughly estimated as 20-30% of the price, so it is usually something between 1 and 30 USD. The user can choose either to receive a payback, or to donate the money (FIG. 4c). A donation screen is displayed by clicking on Donate payback button. According to example implementation, the Red Cross organization is offered as a donation receiver and World Wildlife fund as an alternative. In general, any reasonable number of organizations can be displayed in the screen. The user can also choose to enter in email field on the previous screen email of another organization or email of a Pocket PC User Club, for example. The chosen organization will receive a notification about the payback and can decide what to do with it.

The Reseller (a person who has a program) can decide how to go about payback. He can choose between the “Donate payback” option and the split payback “50/50”option. By choosing a 50/50 option, the price of the application is decreased for a buyer by 50% of the full payback and the reseller gets only 50% of payback.

The last screen (FIG. 4d) displays instructions providing some practical support for the user to handle an SD card.

The payback is received by the reseller only upon the purchase of the software by a second party.

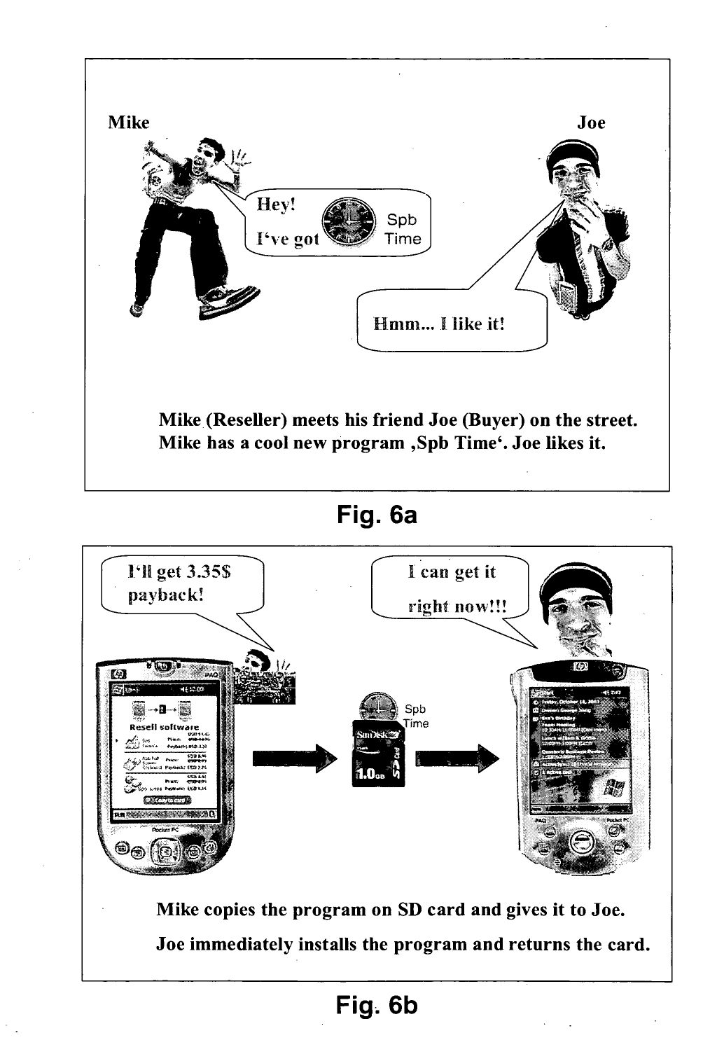

A message flow during the payment process is illustrated in FIG. 5.

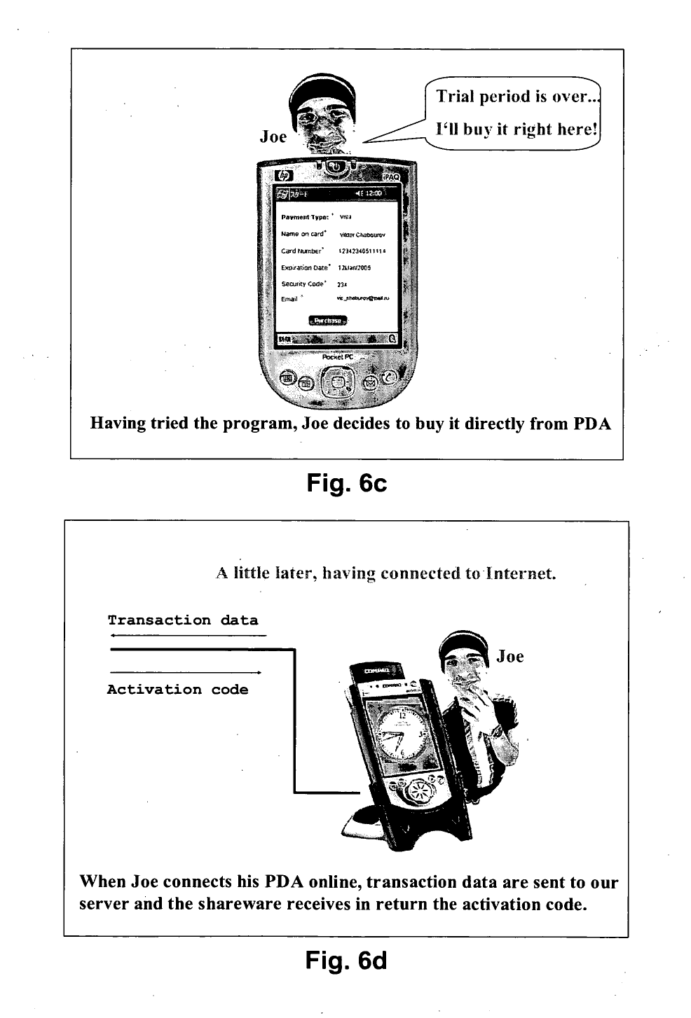

To transfer a software program, a reseller inserts a storage medium with a recorded installable version of a software into another person's PDA (FIGS. 6a, b). Another person can execute the saved installable and as a result the program will be installed on his device. After that, he can return the storage medium to the owner. In one implementation, the installable is started automatically from the SD card, when it is inserted into PDA of the other person.

After the buyer has received the software on his PDA, he can start using it for a trial period and further make a purchase (FIG. 6c).

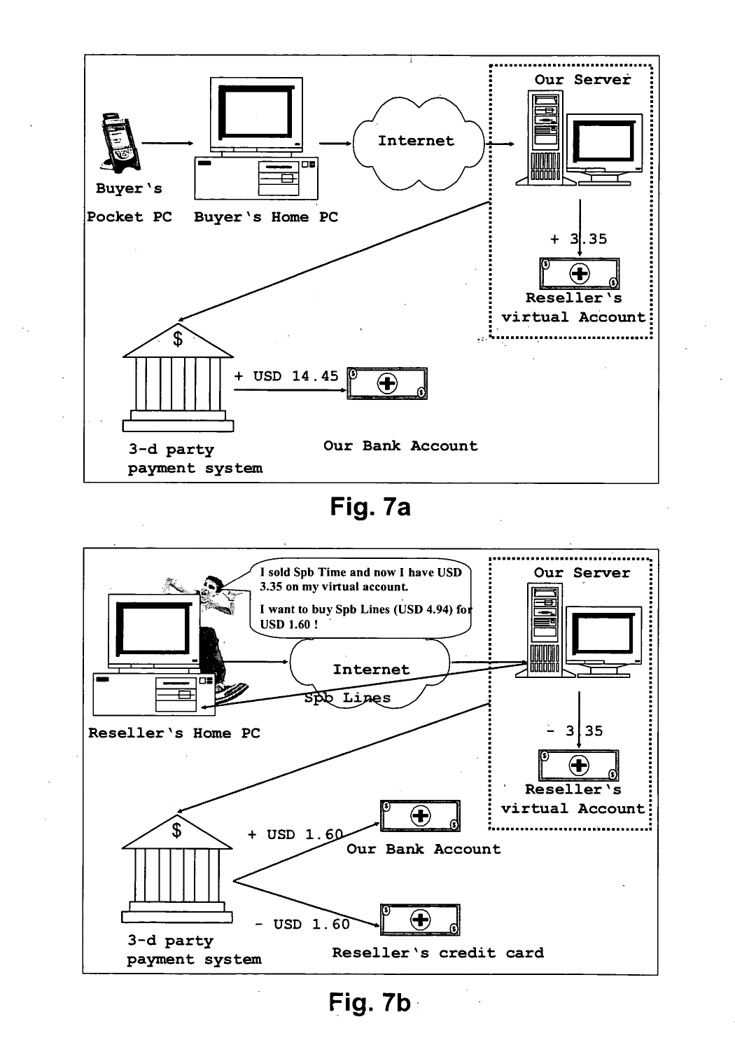

FIG. 7a illustrates a method wherein the second user's PDA is connected to Internet and transaction data with reseller email is passed to a service provider server. A first user account is incremented by the sum of the payback.

Upon the purchase is made, the buyer receives the activation code and the reseller receives a payback payment on his virtual account located on the server (FIG. 7a).

FIG. 7b illustrates a method wherein the first user (reseller) is connected to Internet and a service provider website. There, he logs into the system using his email as a login and sees that he has money received for reselling software program. He can spend the money on some other software programs from the website. In this example he chooses to purchase a new program and has to pay only the difference between a program price and a sum accumulated in his virtual account.

FIG. 7c illustrates a method wherein the first user has accumulated a sufficient sum of money to request transfer to his bank account or PayPal account.

The reseller can receive an email notification. The reseller can spend the payback to buy additional software or accumulate a larger sum (the minimum is set by us, for example 100 USD) and request a transfer to his bank account or to online account like PayPal (FIGS. 7b, c).

Technically it is performed by storing a payback email within the installable. When the transaction is executed, the payback email is passed to a service provider server. The service provider server recognizes the reseller of this application and his virtual account can be incremented by the amount of payback, whereupon, a notification email is sent to his email address.

This reselling possibility is enabled in the application by providing a client-side SDK that can be integrated by shareware developers-into the programs.

Optionally, the software transferred in this way can be provided with an optional function, to ensure the newly installed software program doesn't accept the registration key of the first PDA user but allows purchasing the software directly on a device.

According to example implementation, SDK contains reselling screens, information screens, end-user help documentation and developer integration documentation. It also contains offline payment screens.

It provides API that can be used by the shareware developer to display the Reselling and Payment screens.

Additional optional API is provided to check that the same registration key is not used on another computer. This can be helpful to prevent end-users from sharing a registration key along with sending the shareware program to a third party.

Installable versions of a software program to be re-sold are created by integration of API into the application setup process. According to the present invention, SDK provides a possibility to create the installable version on the flight, from the existing installation of the programs from program files, used DLLs, registry values, etc, based on program installation manifest.

The shareware developers can incorporate this functionality into their software so as to integrate with the software reselling system. The software code for adding service provider functionality to the software of a shareware developer is available in the form of a service provider Software Development Kit (SDK). According to the invention, a shareware developer integrates the SDK into a software product.

The invention will be further described with reference to one of the possible example implementations called “Handster”, which in no means limits the invention. The scope of protection of the invention is defined by the appended claims and its equivalents.

The Handster payment functionality can be integrated as follows.

For initialization of a Handster library HS_lnitLibrary (LPHS_PRODung_INFO) is called, which initializes the payment functionality. The following code describes how to use HS_PRODUCT_INFO structure:

typedef struct _HS_PRODUNC_INFO
{

| | |
|---|---|
| HINSTANCE hResInstance, | // Resource module handle |
| HKEY hAppRootKey, | // Handle to a root registry key (for example HKEY_LOCAL_MACHINE) |
| LPCTSTR pszAppRegPath, | // Path to registry subkey where application information is stored |

LPCTSTR pszPathToLibraryFiles, //Path to program installation (equal to pszInstallDir used for HSSetup
//You can use NULL for parameter, in this case the library uses path to own location
// For registration information

| | |
|---|---|
| HKEY hRegRootKey, | // Handle to a root registry key (for example HKEY_LOCAL_MACHINE) |
| LPCTSTR pszRegRegPath, | // Path to registry subkey where registration key is stored |

LPCTSTR pszRegRegValueName, // Name of registry value where registration key is stored

| | |
|---|---|
| LPCTSTR pszRegStaticKey | // Valid registration key |
| HWND hMainWnd; | //Handle to main window. Optional - can be set separately also. |
| }; | |

Optionally, if you want to set parent window for the dialogs in different place from initialization-call HS_SetMainWindow(hMainWnd).

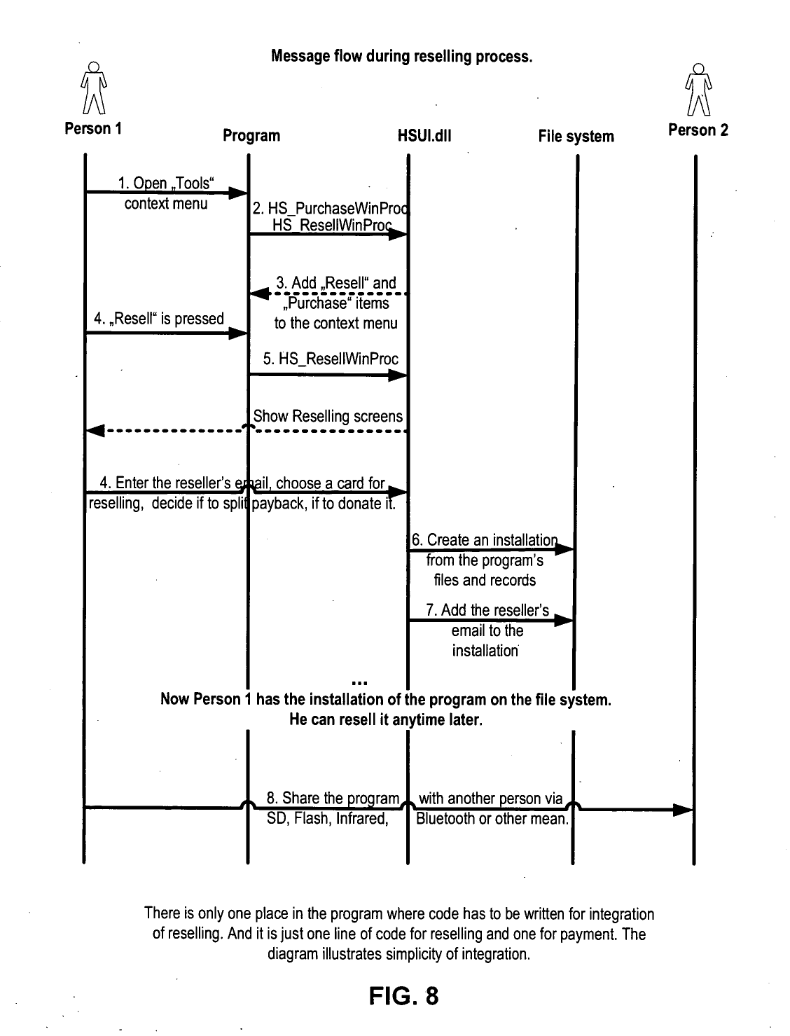

To show a “Try/Buy” dialog on startup of an application and on specific actions, for example “New game” in game applications, call, for example HS_ShowTryPurchaseScreen(bDrawFirstscreen=TRUE).This function is used to display payment screens and register network search. It provides a user with screens for credit card input and stores encrypted information on PDA. Later, when Internet connection to a transaction server is available, a network search listener sends it over SSL connection to the transaction server. If bDrawFirstScreen is set to a false value, the library will not display the first screen (FIG. 9a) and start with the credit card input screen. (FIG. 9b). If a user entered his credit card and it is correctly validated, this function returns true.

Optionally, another method, which will be further described in the present implementation as “HS_IsHandster( )” method can be used to find out if the Handster reselling/payment functionality is enabled in the product. Usually used in if statements, when different code has to be executed, depending in which mode product is running, with Handster or without Handster functionality. The method HS_PurchaseResellWinProc( ) is added into the ‘WindowProc’ method handler in the program. This method is responsible for dynamically adding the “Resell” and “Purchase” buttons and for dynamically adding handlers for these 2 buttons.

Advantageously, dynamically adding button and handler in just one line of the code considerably simplifies the integration.

Alternatively, both methods, includingHS_PurchaseWinProc( ) and HS_ResellWinProc( ), can be used, in case the buttons has to be added in different places.

### EXAMPLE

```
LRESULT CFreeCellDlg::WindowProc(UINT message, WPARAM
wParam, LPARAM lParam)
{
    HS_PurchaseWinProc(hWnd, message, wParam, lParam,
    0xF000, 3);
    HS_ResellWinProc(hWnd, message, wParam, lParam, 0xF000, 4);
    // The last 2 parameters are Popup index and Item in popup index,
    where buttons should be added
return CDialog::WindowProc(message, wParam, lParam);
}
```

To this end, in program's Setup library functions HS_lnstalilnit( ); and HS_Uninstalllnit( ) are added into. Install_Init and Uninstall_Init correspondingly.

The function HS_lnstalllnit(LPCTSTR szNormalCabName, LPCTSTR szFullApplicationName, LPCTSTR pszlnstallDir) is inserted at the beginning of Install_Init function. This function has next parameters:
szNormalCabName—name of a cab file which you want to store.
szFullApplicationName—full name of the application, generated by a cab wizard.

This name is currently a combination of “Provider” and “AppName” fields from configuration “inf” file.
pszlnstallDir—path of the installation, passed by the system to Install_Init function.

The following code shows how to use HS_Instalilnit structure:

| codeINSTALL_INIT | |
|---|---|
| Install_Init( | |
| HWND | hwndParent, |
| BOOL | fFirstCall, |
| BOOL | fpreviouslyInstalled, |
| LPCTSTR | pszInstallDir |

```
)
{
        HS_InstallInit( _T(“SuperProduct.cab”), _T(“Super
Company Super Product”), pszInstallDir)
        // ... Your custom code
        return codeINSTALL_INIT_CONTINUE;
}
```

Function HS_Uninstalllnit(LPCTSTR szNormalCabName, LPCTSTR pszInstallDir) is inserted at the beginning of Uninstall_Init function. All parametres are identical with the parametres from the previous.

The following code describes how to use HS_Uninstalllnit structure:

| codeUNINSTALL_INIT | |
|---|---|
| Uninstall_Init( | |
| HWND | hwndParent, |
| LPCTSTR | pszInstallDir |

```
)
{
        HS_UninstallInit(_T(“SuperProduct.cab”), pszInstallDir);
        // ... Your custom code
        return codeUNINSTALL_INIT_CONTINUE;
}
```

To summarize the above described integration it shall be appreciated that the Handster SDK can be integrated with minimal lines of code. In most cases 5 method calls, added at the right places into a developer's application are sufficient. These method calls are:

1) HS_InitLibrary //Added in program in initialization section.
2) HS_ShowTryPurchaseScreen //Added to startup code of application
3) HS_PurchaseResellWinProc //Added to WinProc function
4) HS_InstallInit //Added to INSTALL_INIT
5) HS_UninstallInit //Added to UNINSTALL _INIT

Additionally, in the implementation of all these methods the availability of already embedded mechanisms for re-selling of software is checked. In this implementation it is done by checking a build-time defined registry value of application.

An application developer defines registry properties in the INF file of an application, indicating if this application setup contains Handster functionality or not.

Additional helper program inf_update.exe is provided for the application developers. This program receives INF file name as a pair of input and key values, that it writes into INF file. It finds section with the key name in INF file and adds to this section value record.

### EXAMPLE

inf_update “SpbFreeCell.inf” SourceDisksFiles “HSUI.dll=1” Files.Common “HSUI.dll,,,0” RegSettings.All
“HKLM,Software\Spb Software House\Spb FreeCell,HS_ProdName, 0x00000000,Spb FreeCell” RegSettings.All
“HKLM,Software\Spb Software House\Spb FreeCell,HS_CabName, 0x00000000,SpbFreeCell.arm.CAB”
RegSettings.All“HKLM,Software\Spb Software House\Spb FreeCell,HS_Price, 0x00000000,4.95” RegSettings.All
“HKLM,Software\Spb Software House\Spb FreeCell,HS_Icon, 0x00010001,128”

Thus, the application developer can define if a current application has additionally some Handster-functionality relevant properties in its registry and also install HSUI.dll in the device.

In any Handster library method, it is checked first, if the executed build of an application supports the Handster functionality. If the application builddoes not contain the above call to inf_update that updates INF file and adds Handster related information, it means that this version should not display any Handster functionality. In such a case the method exits without performing any actions.

Further extensions of the program's User Interface are made dynamically. For example, the buttons “Purchase” and “Resell” are added dynamically. It means that if the Handster functionality is not enabled in the build, the methods functioning to add the buttons are not executed and these buttons are not added.

The same can be mentioned about the calls to display a “Try/buy” screen. If the Handster functionality is not enabled at build-time, the method exits and the dialogs are not displayed.

The benefit of using the above described method of integration according to the invention is that the inventive Handster library provides using the same executable code to the Handster-enabled applications and applications having no Handster functionality. The only difference is in INF file of setup build. Each of these methods checks if there are Handster-enabling parameters for a current application, and if not, returns without execution.

This is a major benefit for application developers, because they do not need to support 2 code versions for products with Handster functionality and without it.

The reselling possibility can be provided by building a stand-alone application that allows reselling of the products existing on the market, without any integration. The example implementation of this application, called HandsterReseller.exe, contains a database of all vendors with whom a re-seller has reselling agreements. Further, it contains information about application names, icons, prices and optionally, a program registration key and a path in the registry where the registration key is stored.

The HandsterReseller creates an installable of the application based on the installed program.

During the application installation, a path in the startup icon can be substituted to launch HandsterStartup.exe application. This application first retrieves the name, icon and price of the application being resold and, secondly, displays the payment screens for the end-user with this information. If the user purchases the application, the transaction is executed, while the device is connected online.

If HandsterReseller.exe version has a program registry key and a path in the registry where it can be written to, the HandsterReseller.exe uses it to enable the program for 2 weeks after the purchase.

If there is no information, the application is not enabled, but after the transaction is executed, the user gets a message, containing the registration key, retrieved from the server, together with the description how to register the application using this key.

When the above described application is implemented, it can be possible for end-users to resell already installed applications. The end-user doesn't have to reinstall applications to get Handster-enabled versions and developers are not required to integrate the Handster API.

A system for re-selling of software according to the invention will be further described in more detail with reference to FIGS. 7a-7c.

The software reselling system shown in FIGS. 7a-7c, comprises a first user's (reseller's) hardware devices, such as PC and/or Pocket PC, a second user's (buyer's) hardware devices, such as PC and/or Pocket PC, a service provider equipment, such as a web server and service provider database, and a third party payment system equipment.

The first user hardware devices, second user hardware devices, service provider equipment, third party payment system equipment can communicate with each other over a communications network, such as the Internet.

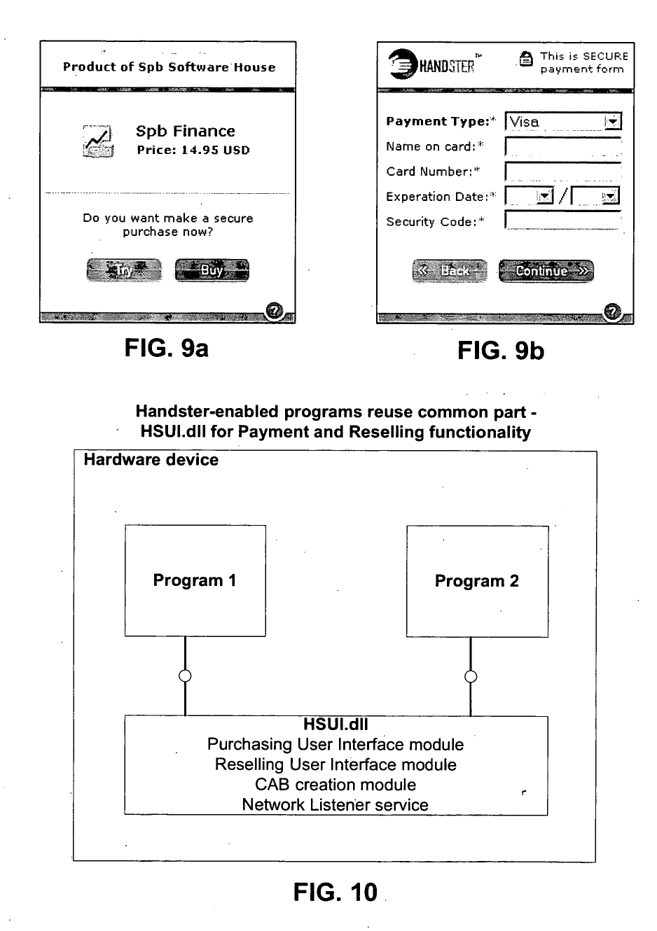

The first user hardware device comprises software having embedded mechanism for enabling the reselling and purchasing of the software program. The embedded mechanism (HSUI.dll) comprises some modules (FIG. 10), such as Purchasing User Interface module, Reselling User Interface module, CAB creation module and Network Listener service.

Reselling (or ‘relicensing’) of software can be implemented also for desktop software, not necessary only PDA software. In such case the software program gives the end user a possibility to ‘burn’ its installable on a .CD, which he can pass to another person. Another person can install it and buy it using integrated payment screens. When the transaction is executed, the first person receives payback to his account. This will create the possibility to sell software based on user-references. There is a major benefit for end-users, because they get the best what is on the market—something that was already tried by someone and recommended. And there is a benefit for software vendors because this type of selling requires lower marketing expenses—users choose themselves the best product and distribute them.

We claim:

1. A method for peer-to-peer reselling of a software program, comprising:
creating a new installable version of the software program on a hardware device of a first user, wherein the software program comprises embedded mechanism for enabling re-selling of the software program;
transferring the new installable version of the software program to at least one other hardware device;
executing transaction to purchase the software program by at least one other user when connecting the said at least one other hardware device to a server;
enabling payback mechanism so that the first user receives a payback.

2. The method of claim 1, wherein the embedded mechanism provides repeated reselling of the software program, to enable a plurality of at least one subsequent reselling operation.

3. The method of claim 1, wherein the first user is assigned a virtual payback account on the server, to enable the payback.

4. The method of claim 1, wherein the embedded mechanism enables a secure transaction to purchase the software program offline.

5. The method of claim 1, wherein the software program is enabled upon transfer of the program to on at least one other hardware device whereby the user of the said at least one other hardware device can start using the software program.

6. The method of claim 1, wherein the software program is recorded on a portable program carrier, such as a SecureDigital card, CompactFlash card, CD or DVD, to transfer to the second hardware device.

7. The method of claim 1, wherein the software program is transferred by e-mail, Infrared or Bluetooth, Wi-Fi or other wireless channel.

8. The system of claim 1, wherein the embedded mechanism comprises a means for creating/capturing a user/hardware device identifier selected but not limited to: an e-mail address, user name, or a unique computer device ID.

9. The method of claim 8, wherein each time a new installable version of the software program is created, the identifier of the first user and each subsequent user is transferred with the software program to the each subsequent hardware device and on to the server.

10. The method of claim 2, wherein each subsequent user involved in reselling is assigned a level number, which is defined by the number of reselling operations occurred before, wherein the said level number is transferred along with the user identifier to the server.

11. The method of claim 9, wherein the identifier is transferred to the server when online, for example, during subsequent transaction.

12. The method of claim 11, wherein the virtual payback account of the first user is created using the identifier to enable transfer of the payback sum to the first user virtual account upon the purchase of the software program by the second user

13. The method of claim 3, comprising searching for existing payback virtual account of the first user using the identifier upon the purchase of the software, program by the second user.

14. The method of claim 1, comprising sending a payback notification to the first user, for example, by e-mail.

15. The method of claim 1, wherein the hardware device is selected from PDA, a desktop computer, a mobile phone

16. The method of claim 1, wherein the embedded mechanism rejects a registration key of the first user hardware device upon installation of the software program on the at least one other hardware device.

17. A system for peer-to-peer reselling of a software program, comprising:
means for creating a new installable version of the software program on a hardware device of a first user; wherein the software comprises embedded mechanism for enabling reselling of the software program; comprising means for enabling transaction to purchase the software program upon transfer to at least one other hardware device by at least one other user when connecting the said at least one other hardware device to a server; and
means for enabling payback mechanism, so that the first user receives a payback.

18. The system of claim 17, comprising means for transferring the new installable version of the software program to at least one other hardware device.

19. The system of claim 17, wherein the embedded mechanism provides at least a one time re-selling of the software program.

20. The system of claim 17, wherein the embedded mechanism further comprises means for installing the software program.

21. The system of claim 17, wherein the new installable version of the software program is created using program files and records available on the at least one other computer device.

22. The system of claim 17, wherein the embedded mechanism comprises means for capturing a user/hardware device identifier and transferring the identifier to the server when online.

23. The system of claim 17, wherein the embedded mechanism comprises means for creating a new payback virtual account of the first user using the identifier, or a means for searching for existing payback virtual account of the first user using the identifier.

24. The system of claim 18, wherein the means for transferring the software program comprises portable program carrier, such as CD, DVD, or the like.

25. The system of claim 18, wherein the hardware device is selected from PDA, a desktop computer, a mobile phone.

26. A computer program product for peer-to-peer reselling of a software, program, comprising an embedded mechanism for enabling reselling of the software program; wherein the embedded mechanism comprises:
a computer readable program code means for creating a new installable version of the software program on a first user hardware device,
a computer readable program code means for enabling transaction to purchase the software program when connecting the said at least one other hardware device to the server;
a computer readable program code means for enabling a payback mechanism.

27. The computer program product of claim 26, comprising a computer readable program code means for enabling-transaction to purchase the software program.

28. The computer program product of claim 26, wherein the embedded mechanism further comprises a computer readable program code means for enabling the software program on a first user hardware device, whereby the first user can use the software program.

29. The computer program product of claim 27, wherein the embedded mechanism further comprises a computer readable program code means for enabling a software program on at least one other hardware device, whereby the at least one other user can start using the software program upon transfer of the new installable version.

30. The computer program product of claim 26, wherein the embedded mechanism comprises a computer readable program code means for enabling transfer of the software program by email or recording of the software program on a portable program carrier.

31. The computer program product of claim 26, comprising a computer readable program code means for enabling transfer of an identifier of the first user with the software program to the at least one other hardware device and on to the server.

32. The computer program product of claim 26, comprising a computer readable program code means for dynamically modifying a program's Graphical User Interface and dynamically adding functionality, like buttons handlers, payment/reselling dialogs.

33. A computer server for peer-to-peer reselling of a software program, comprising:
a means for creating an installable version or versions of a software program, wherein the installable version comprises the software program itself and embedded mechanism for enabling reselling the software program;
a means for transferring the installable version of the software program to a first user computer device, so that the first user can either purchase the program or resell the program to another user;
a means for enabling transaction to purchase the software program when connecting the server to at least one hardware device having installed the installable version of the program comprising the embedded reselling mechanism;
a means for enabling a payback when connecting the said at least one hardware device to the server.

34. The server of claim 33, wherein the embedded mechanism comprises a means for creating/capturing a user/hardware device identifier, such as selected from an e-mail address, user name, or a unique computer device ID.

35. The server of claim 33, wherein the means for enabling a payback comprises a means for creating a user virtual payback account, so that the payback sum can be added to the user virtual payback account upon the purchase of the software program.

36. The server of claim 33, comprising a means for'sending a payback notification to the first user upon the purchase of the software program by at least one other user.

37. The server of claim 33, comprising a means for sending a software program registration key upon the purchase of the software program.

38. The server of claim 33, wherein the means for enabling a payback comprises a means for enabling payback donation.

39. The server of claim 33, wherein the means for enabling a payback comprises a means for enabling split payback between the first and the second user. Thus the second user receives discount on product and the first user receives reduced payback.

40. The server of claim 37, wherein the means for creating an installable version of a software program comprises a means for enabling/disabling reselling and payment functionality.

41. The server of claim 37, wherein the reselling and payment functionality is enabled/disabled by adding or removing record from a setup configuration file.

42. The server of claim 37, further comprising means for dynamically modifying the software program Graphical User Interface and dynamically adding functionality, like buttons handlers, payment/reselling dialogs.

43. The server of claim 37, further comprising simplified integration of payment/reselling functionality with only 5 lines of code.
